(19) United States
(12) Patent Application Publication
(10) Pub. No.: US 2006/0288058 A1
(43) Pub. Date: Dec. 21, 2006

(54) Backup/recovery system and methods regarding the same

(75) Inventors: Sword Wu, Chongqing (CN); Tree Yan, Chongqing (CN)

Correspondence Address: ARENT FOX PLLC, 1050 CONNECTICUT AVENUE, N.W., SUITE 400, WASHINGTON, DC, 20036, US

(73) Assignee: FARSTONE TECH., INC.

(21) Appl. No.: 11/413,215

(22) Filed: Apr. 28, 2006

(30) Foreign Application Priority Data
Apr. 28, 2005 (TW) 94113570

(51) Int. Cl. G06F 17/30

(52) U.S. Cl. 707/204

(57) ABSTRACT

A backup/recovery system and methodology that integrates backup data of a computer system with a recovery program. According to the invention, an executable program is created for implementing a backup/recovery procedure. The invention is no need to have a recovery system operated in the computer system, so as to facilitate the user.

### CROSS-REFERENCE TO RELATED APPLICATIONS

The present application claims priority under 35 U.S.C. §119 to Taiwanese Patent Application No. 94113570, filed Apr. 28, 2005, the contents thereof incorporated by reference herein in its entirety.

### BACKGROUND OF THE INVENTION

1. Field of the Invention

The present invention relates generally to a backup/recovery technique for a computer system, and more particularly to a backup/recovery system and method that integrates backup data with a recovery program.

2. Description of Prior Art

Conventional backup/recovery software establishes recovery points to backup data. For example, the conventional backup/recovery software, such as the Ghost software developed by Symantec Corporation, includes a backup program to back up all data stored in selected partitions of the hard disk to a file.

In addition, the Ghost software further includes a recovery program for restoring the data from the file to the selected partitions of the hard disk. Prior to restoring the hard disk, the Ghost software implements its own recovery program. It recognizes the backed-up data of the recovery point established by the Ghost software.

Nevertheless, the conventional backup/recovery software is stored in a region of the hard disk that other programs can have access also. This would likely induce the backup/recovery program to be destroyed. It would be almost impossible to restore the hard disk with any recovery points for that has already been destroyed. As a result, the recovery point even though may be secured, the backup/recovery program is required to recover data in the hard disk.

The user can create a rescue CD that can be run after a system disaster. The backed-up data can be burned onto CD-R/RW so that the user is able to restore the computer in just a few minutes. The user will need a burn software, such as NERO, to make the rescue CD. Also at least a CD-ROM and a writer will be required in their computer system.

### SUMMARY OF THE INVENTION

The present invention provides a backup/recovery system and method to resolve the foregoing problems faced by the conventional backup/recovery software. The present invention also has the advantage of providing a convenient solution to the user.

An object of the present invention is to provide a backup/recovery system and method, wherein a backup file can boot itself and restore the computer system.

Another object of the present invention is to provide a backup/recovery system and method, which can restore the computer system without a CD-ROM or even though a recovery system.

In accordance with an aspect of the present invention, a backup system is installed in a computer system. The backup system comprises a backup module and a processing module. The backup module is used for backing up data contained in the computer system. The processing module is used for processing the backed up data and creating a backup file embedded a recovery code. The backup file implements a backup/recovery procedure without the computer system having a recovery system.

In the preferred embodiment of the invention, the backed up data includes valid data being changed within a data storage device of the computer system. The backed up data includes all valid data within a data storage device of the computer system. The backup file comprises messages. The message includes identification information regarding environment of the backup/recovery procedure. The message includes identification information of the backup file.

In accordance with another aspect of the present invention, a backup method is suitable for a computer system. The backup method comprising the steps of: backing up data contained in the computer system, and processing the backed up data and creating a backup file embedded a recovery code. The backup file implements a backup/recovery procedure without the computer system having a recovery system.

In the preferred embodiment of the invention, the backed up data includes valid data being changed within a data storage device of the computer system. The backed up data includes all valid data within a data storage device of the computer system. The backup file comprises message. The message includes identification information regarding environment of the backup/recovery procedure. The message includes identification information of the backup file.

The present invention may best be understood through the following description with reference to the accompanying drawings, in which:

### BRIEF DESCRIPTION OF THE DRAWINGS

FIG. 1 shows a schematic block diagram of a backup file of a preferred embodiment according to the present invention.

FIG. 2 shows a schematic flow chart of a backup method of the preferred embodiment according to the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for the purpose of illustration and description only. It is not intended to be exhaustive or to be limited to the precise form disclosed.

The present invention describes a new backup technique for a backup/recovery system to create a backup file embedded a recovery code, which can implement a backup/recovery procedure without a recovery system. Moreover, the users will have no inconvenience and difficulty in burning the rescue CD. Accordingly, the problem can be solved, the protective capability and the efficiency of the described backup/recovery system can be increased. The presently described backup/recovery system, thus, serves users' demands much more adequately.

With the backup technique of the present invention, the users can securely back up and/or restore data promptly. Therefore, the drawbacks faced by the prior arts can be solved completely.

According to the preferred embodiment of the present invention, a backup system is installed in a computer system. The backup system comprises a backup module and a processing module. The backup module is used for backing up data contained in the computer system. The processing module is used for processing the backed up data and creating a backup file embedded a recovery code. The backup file implements a backup/recovery procedure without the computer system having a recovery system.

The backed up data includes valid data being changed within a data storage device of the computer system. The backed up data includes all valid data within a data storage device of the computer system. The backup file comprises messages. The message includes identification information regarding environment of the backup/recovery procedure. The message includes identification information of the backup file.

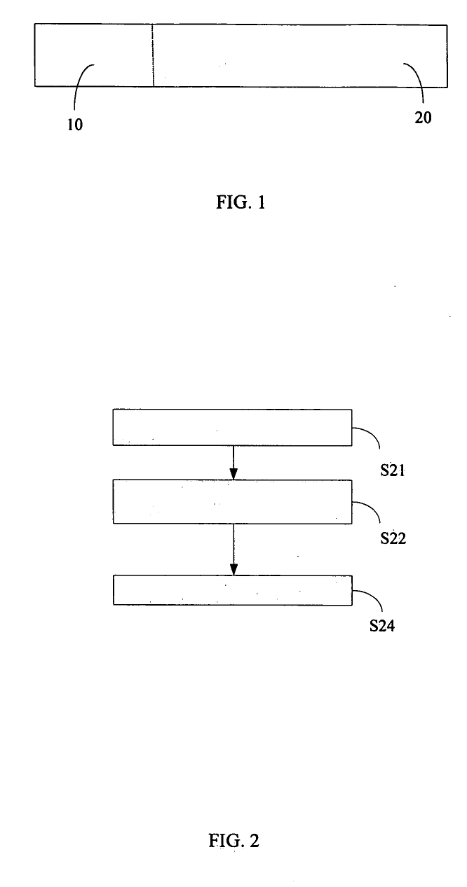

Referring to FIG. 1, a schematic block diagram of a backup file of a preferred embodiment according to the present invention is shown. The backup/recovery system of the present invention is installed in a computer system. The backup system comprises a backup module and a processing module. The backup module is used for backing up data contained in the computer system. For example, data from a partition on a hard drive is backed up

The processing module is used for processing the backed up data 20 and creating a backup file embedded a recovery code 10. The backup file can boot itself and implements a backup/recovery procedure without the computer system having a recovery system. The backed up data includes valid data being changed within a data storage device of the computer system. The backed up data includes all valid data within a data storage device of the computer system. Every backup file itself is embedded a recovery code 10.

The backup file comprises messages. The message includes identification information regarding environment of the backup/recovery procedure. The message includes identification information of the backup file.

According to the preferred embodiment of the present invention, a backup method is suitable for a computer system. The backup method comprising the steps of: backing up data contained in the computer system, and processing the backed up data and creating a backup file embedded a recovery code. The backup file implements a backup/recovery procedure without the computer system having a recovery system.

The backed up data includes valid data being changed within a data storage device of the computer system. The backed up data includes all valid data within a data storage device of the computer system. The backup file comprises message. The message includes identification information regarding environment of the backup/recovery procedure. The message includes identification information of the backup file.

Referring to FIG. 2, a schematic flow chart of a backup/recovery method of the preferred embodiment according to the present invention is shown. According to the present invention, the backup/recovery method of the present invention is suitable for computer system.

In step S21, data from a partition on a hard drive is backed up The backed up data includes valid data being changed within a data storage device of the computer system. The backed up data includes all valid data within a data storage device of the computer system.

In step S22, a backup file is created in accordance with the backed up data. The backup file embeds a recovery code. The backup file comprises messages. The message includes identification information regarding environment of the backup/recovery procedure. The message includes identification information of the backup file.

In step S24, the backup file can boot itself and implements a backup/recovery procedure without the computer system having a recovery system.

The present invention makes backup data with recovery program so that the backup file can effectively solved the ruin problem faced by the conventional backup/recovery software. Hence, the shortcoming that the computer system cannot be restored to a normal state can be entirely avoided.

While the invention has been described in terms of what are presently considered to be the most practical and preferred embodiments, it is to be understood that the invention need not be limited to the disclosed embodiment. On the contrary, it is intended to cover various modifications and similar arrangements included within the spirit and scope of the appended claims which are to be accorded with the broadest interpretation so as to encompass all such modifications and similar structures.

1. A backup system, which is installed in a computer system, said backup system comprising:
a backup module for backing up data contained in said computer system, and
a processing module coupled to said backup module for processing said backed up data and creating a backup file embedded a recovery code, wherein
said backup file implements a backup/recovery procedure without said computer system having a recovery system.

2. The backup system according to claim 1, wherein said backed up data includes valid data being changed within a data storage device of said computer system.

3. The backup system according to claim 1, wherein said backed up data includes all valid data within a data storage device of said computer system.

4. The backup system according to claim 1, wherein said backup file comprises message.

5. The backup system according to claim 4, wherein said message includes identification information regarding environment of said backup/recovery procedure.

6. The backup system according to claim 4, wherein said message includes identification information of said backup file.

7. A backup method, suitable for a computer system, said backup method comprising the steps of: backing up data contained in said computer system, and processing said backed up data and creating a backup file embedded a recovery code, wherein said backup file implements a backup/recovery procedure without said computer system having a recovery system.

8. The backup method according to claim 7, wherein said backed up data includes valid data being changed within a data storage device of said computer system.

9. The backup system according to claim 7, wherein said backed up data includes all valid data within a data storage device of said computer system.

10. The backup system according to claim 7, wherein said backup file comprises message.

11. The backup system according to claim 10, wherein said message includes identification information regarding environment of said backup/recovery procedure.

12. The backup system according to claim 10, wherein said message includes identification information of said backup file.
